(19) United States
(12) Patent Application Publication
(10) Pub. No.: US 2015/0061816 A1
(43) Pub. Date: Mar. 5, 2015

(54) MAGNETIC COMPOSITION AND MULTILAYER ELECTRONIC COMPONENT MANUFACTURED BY USING THE SAME

(71) Applicant: SAMSUNG ELECTRO-MECHANICS CO., LTD., Suwon (KR)

(72) Inventors: Bum Suk KANG, Suwon (KR); Young Il LEE, Suwon (KR); Hee Sang KANG, Suwon (KR); Byeong Cheol MOON, Suwon (KR); Hew Young KIM, Suwon (KR); Chang Joo LEE, Suwon (KR)

(73) Assignee: SAMSUNG ELECTRO-MECHANICS CO., LTD., Suwon (KR)

(21) Appl. No.: 14/084,557

(22) Filed: Nov. 19, 2013

(30) Foreign Application Priority Data
Sep. 5, 2013 (KR) 10-2013-0106570

(51) Int. Cl. H01F 1/01; H01F 27/24

(52) U.S. Cl. CPC H01F 1/01; H01F 27/24
USPC 336/212; 252/62.6

(57) ABSTRACT

There are provided a magnetic composition including a glass component capable of not reacting with a ferrite grain but being uniformly distributed only in a grain boundary, instead of using an existing glass component, thereby achieving improved permeability, specific resistance and high frequency specific resistance, and a multilayer electronic component manufactured by using the same.

### CROSS-REFERENCE TO RELATED APPLICATION

This application claims the benefit of Korean Patent Application No. 10-2013-0106570 filed on Sep. 5, 2013, with the Korean Intellectual Property Office, the disclosure of which is incorporated herein by reference.

### BACKGROUND

The present disclosure relates to a magnetic composition having improved permeability, specific resistance and high frequency specific resistance values, and a multilayer electronic component manufactured by using the same.

An electronic component such as an inductor, a multilayer ceramic capacitor, a piezoelectric element, a varistor, a thermistor, or the like, generally includes a body formed of ceramic materials, metal internal electrodes formed in the body, and external electrodes formed on a surface of the ceramic body and connected to the internal electrodes.

Recently, as electrical and electronic products have rapidly progressed to have a small size, a lightweight and high function, a trend in which inductors used therein also have a small size and high capacitance has increased. Therefore, a ferrite used as a magnetic material of an inductor is demanded to have high permeability and high specific resistance. In order to achieve high permeability and high specific resistance, a resistance value applied to a grain boundary of the ferrite after sintering should be high.

Meanwhile, at the time of manufacturing the inductor, a glass is used to sinter the ferrite at a relatively low temperature. The reason is that the glass dispersed in the ferrite is to be in a liquid state to promote material movement of the ferrite component such that the sintering is completed at the relatively low temperature. In addition, vacancies of the sintered ferrite structure are filled with the glass having relatively high fluidity, such that a sintering density and reliability may be improved.

However, in the case in which a ferrite composition having the glass added thereto is used to form a ceramic body, the following side effects may be caused depending on a kind or an amount of added glass, a particle size of a ferrite powder, a dispersion state of the ferrite composition, a sintering heat treatment temperature, an atmosphere, and the like:

In the case in which an excessive amount of glass is contained in the ferrite composition, the glass during the sintering process does not promote the sintering of the ferrite but increases a material moving distance and decreases a contact point, thereby causing a non-sintering;

The glass is reacted with ferrite grains in the sintering process to decrease internal resistance of the ferrite grains, thereby causing deterioration of high frequency specific resistance (AC specific resistance); and

\textcircled{3} In the case in which a high temperature fluidity of the glass component is not achieved, the glass component is not uniformly distributed in grain boundaries, such that the maximum specific resistance value (volume fraction occupied by the grain boundaries in the entirety of the ceramic body) capable of being obtained by the grain boundaries may not be obtained to decrease a grain boundary resistance, thereby causing a decrease in permeability and specific resistance.

Patent Document 1 below discloses a magnetic composition including a predetermined amount of specific glass in the ferrite and an electronic component manufactured by using the same. However, in Patent Document 1, permeability may be decreased by an excessive amount of glass and the glass is not uniformly distributed in grain boundaries, resulting in limitations in improving permeability and specific resistance.

### RELATED ART DOCUMENT

(Patent Document 1) Japanese Patent Laid-Open Publication No. 2010-150051

### SUMMARY

An aspect of the present disclosure may provide a magnetic composition having improved permeability, specific resistance and high frequency specific resistance values by preventing a glass added thereto from reacting with a ferrite grain while allowing the glass to be uniformly distributed in a ferrite grain boundary at the time of sintering, and a multilayer electronic component manufactured by using the same.

According to an aspect of the present disclosure, a magnetic composition may include a ferrite and a glass, wherein the glass may include an oxide including at least one selected from a group consisting of silicon (Si) and boron (B); an oxide including at least one selected from a group consisting of lithium (Li), potassium (K) and calcium (Ca); an oxide including at least one selected from a group consisting of vanadium (V) and manganese (Mn); and an oxide including at least one selected from a group consisting of titanium (Ti) and aluminum (Al).

The glass may include the oxide including at least one selected from a group consisting of vanadium (V) and manganese (Mn) in an amount of 10 mol % to 40 mol %.

When a molar ratio of the oxide including at least one selected from a group consisting of silicon (Si) and boron (B) is a, a molar ratio of the oxide including at least one selected from a group consisting of lithium (Li), potassium (K) and calcium (Ca) is b, a molar ratio of the oxide including at least one selected from a group consisting of vanadium (V) and manganese (Mn) is c, and a molar ratio of the oxide including at least one selected from a group consisting of titanium (Ti) and aluminum (Al) is d, a, b, c, and d may satisfy the following equations: a+b+c+d=100(mol %); 30(mol %) a 60 (mol %) ; 10(mol %)≦b≦30(mol %); 10(mol %)≦c≦40(mol %); and 1(mol %)≦d≦20(mol %).

The glass may be included in an amount of 0.5 wt % to 20 wt %.

The glass may have an average particle size of 0.05 ηm to 5 μm.

The ferrite may have an average particle size of 0.05 μm to 5 μm.

The ferrite may include at least one selected from a group consisting of a Mn—Zn-based ferrite, a Ni—Zn-based ferrite, a Ni—Zn—Cu-based ferrite, a Mn—Mg-based ferrite, a Ba-based ferrite, and a Li-based ferrite.

According to another aspect of the present disclosure, a multilayer electronic component may include a magnetic body in which a plurality of magnetic layers are laminated; a conductive pattern formed in the magnetic body; and external electrodes formed on at least one end surface of the magnetic body and electrically connected to the conductive pattern, wherein the magnetic body may include a ferrite and a glass, and the glass may include an oxide including at least one selected from a group consisting of silicon (Si) and boron (B); an oxide including at least one selected from a group consisting of lithium (Li), potassium (K) and calcium (Ca); an oxide including at least one selected from a group consisting of vanadium (V) and manganese (Mn); and an oxide including at least one selected from a group consisting of titanium (Ti) and aluminum (Al).

The glass may include the oxide including at least one selected from a group consisting of vanadium (V) and manganese (Mn) in an amount of 10 mol % to 40 mol %.

When a molar ratio of the oxide including at least one selected from a group consisting of silicon (Si) and boron (B) is a, a molar ratio of the oxide including at least one selected from a group consisting of lithium (Li), potassium (K) and calcium (Ca) is b, a molar ratio of the oxide including at least one selected from a group consisting of vanadium (V) and manganese (Mn) is c, and a molar ratio of the oxide including at least one selected from a group consisting of titanium (Ti) and aluminum (Al) is d, a, b, c, and d satisfy the following equations: a, b, c, and d may satisfy the following equations: a+b+c+d=100(mol %), 30(mol %)≦a≦60(mol %), 10(mol %)≦b≦30(mol %), 10 (mol %)≦c≦40(mol %), and 1 (mol %)≦d≦20(mol %).

The magnetic body may include the glass in an amount of 0.5 wt % to 20 wt %.

The glass may have an average particle size of 0.05 μm to 5 μm.

The ferrite may have an average particle size of 0.05 μm to 5 μm.

The ferrite may include at least one selected from a group consisting of a Mn—Zn-based ferrite, a Ni—Zn-based ferrite, a Ni—Zn—Cu-based ferrite, a Mn—Mg-based ferrite, a Ba-based ferrite, and a Li-based ferrite.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a graph showing permeability depending on a glass content;

FIG. 2 is a perspective view schematically showing a multilayer electronic component according to an exemplary embodiment of the present disclosure; and

FIG. 3 is a cross-sectional view taken along line A-A′ of FIG. 2.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

A magnetic composition according to an exemplary embodiment of the present disclosure may include a ferrite and a glass.

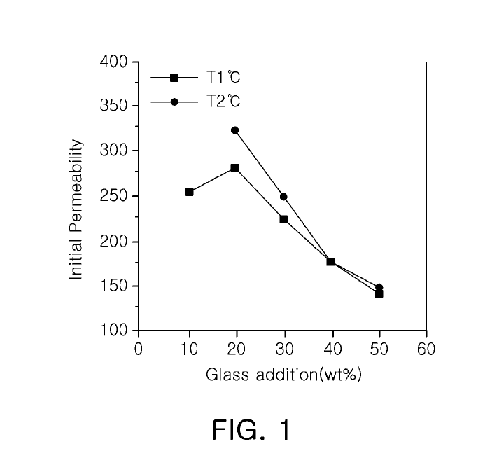

The glass may be included in an amount of 0.5 to 20 wt % with respect to the magnetic composition. In the case in which the glass is included in an amount of less than 0.5 wt %, it may be difficult to implement a liquid-phase sintering mechanism due to glass shortages, and to achieve improved densification through filling vacancies of the ferrite with the glass, and a sintering temperature may be increased, such that electrical properties may be deteriorated and reliability may be decreased. In the case in which the glass is included in an amount of more than 20 wt %, the glass is formed in an excessive liquid phase to increase moving distance of the ferrite base material, such that a grain growth may be suppressed to decrease permeability. FIG. 1 is a graph showing permeability depending on a glass content, and it maybe appreciated from FIG. 1 that as the glass content is more than 20 wt %, permeability is decreased at T1(925° C.) and T2(943° C.)

The glass may include an oxide including at least one selected from a group consisting of silicon (Si) and boron (B); an oxide including at least one selected from a group consisting of lithium (Li), potassium (K) and calcium (Ca); an oxide including at least one selected from a group consisting of vanadium (V) and manganese (Mn); and an oxide including at least one selected from a group consisting of titanium (Ti) and aluminum (Al).

The glass may include a(Si, B)-b(Li, K, Ca)-c(V, Mn)-d(Ti, Al), wherein a refers to a molar ratio of the oxide including at least one selected from a group consisting of silicon (Si) and boron (B), b refers to a molar ratio of the oxide including at least one selected from a group consisting of lithium (Li), potassium (K) and calcium (Ca), c refers to a molar ratio of the oxide including at least one selected from a group consisting of vanadium (V) and manganese (Mn), and d refers to a molar ratio of the oxide including at least one selected from a group consisting of titanium (Ti) and aluminum (Al).

According to the exemplary embodiment of the present disclosure, a, b, c, and d may satisfy the following equation: a+b+c+d=100(mol %), and may satisfy the following equations: 30(mol %)≦a≦60(mol %), 10(mol %)≦b≦30(mol %), 10(mol %)≦c≦40(mol %), and 1(mol %)≦d≦20(mol %).

In order to uniformly bond ceramics by sintering at a high temperature of 400° C. to 1000° C., glass stability and wetting temperature may be important, and may be determined depending on the glass composition.

The glass stability ΔT may be a difference between a crystallization temperature (Tc) and a glass transition temperature (Tg), and may be represented by the following equation: ΔT=Tc−Tg.

In the case in which the glass stability is decreased, when temperature is increased, uniform glass phase may not be formed but some components maybe deposited as crystalline phase, causing compositional non-uniformity on the glass. Therefore, it is important to have excellent glass stability for sintering the ferrite at a high temperature of 400° C. to 1000° C.

In addition, a wetting temperature (Twet), in which a pellet prepared by using a glass powder on a substrate is softened while increasing temperature to have an angle of 90° between the pellet and the substrate, refers to a viscosity of the glass at a high temperature. In the case in which the wetting temperature (Twet) is appropriate, capillary force generated by sintering the base material such as the ferrite and the like and the viscosity of the glass may compositively function, such that the glass may fill the vacancy of the ferrite to improve densification.

The wetting temperature (Twet) is related to a high temperature fluidity of the glass, and in the case in which the wetting temperature between the ferrite powder and the glass powder in the magnetic composition is relatively high as compared to the sintering temperature, the liquid phase sintering is not promoted, such that the sintering temperature may not be decreased, and the glass may not be appropriately distributed in grain boundaries of the ferrite, whereby electrical properties may not be achieved. The glass may be melted to form a molten liquid at a slightly low temperature section as compared to a ferrite sintering temperature section to thereby promote material movement; however, in the case in which the wetting temperature (Twet) is high, the glass may not perform the above-described function. In the case in which the wetting temperature with the ferrite powder is extremely low as compared to the sintering temperature, since spreading of the ferrite powder occurs extremely rapidly as compared to the ferrite sintering section, the spread ferrite powder may be difficult to participate in the sintering reaction, so that permeability may be deteriorated.

Therefore, the glass composition may be adjusted to secure appropriate glass stability by preventing the crystalline phase from being deposited in the ferrite sintering atmosphere and the sintering temperature section, and the wetting temperature (Twet) may satisfy 550° C. to 750° C., which maybe achieved by satisfying the following equations: a+b+c+d=100(mol %), 30(mol %)≦a≦60(mol %), 10(mol %)≦b≦30(mol %), 10 (mol %)≦c≦40 (mol %) , and 1 (mol %)≦d≦20 (mol %) according to the exemplary embodiment of the present disclosure.

In addition, the glass composition according to the exemplary embodiment of the present disclosure may promote the sufficient grain growth of the ferrite at the time of sintering, and a vanadium (V) or manganese (Mn) component for improving grain boundary resistance may be uniformly in the grain boundaries but may not react with the grains, so that permeability, specific resistance, and high frequency specific resistance values may be improved.

The glass may have an average particle size of 0.05 to 5 μm. In the case in which the average particle size of the glass is less than 0.05 μm, it may be difficult to secure dispersibility at the time of preparing a slurry, such that non-uniformity may be increasingly exhibited. In the case in which the average particle size of the glass is more than 5 μm, large glass particles may be molten and vacancy may be formed when the ferrite base material moves and fails to fill the molten portion, resulting in problems in reliability, defective appearance, and decrease in electrical properties.

The ferrite is not specifically limited, and known ferrites such as a Mn—Zn-based ferrite, a Ni—Zn-based ferrite, a Ni—Zn—Cu-based ferrite, a Mn—Mg-based ferrite, a Ba-based ferrite, and a Li-based ferrite may be selected depending on desired properties.

The ferrite may have an average particle size of 0.05 to 5 μm. In the case in which the average particle size of the ferrite is less than 0.05 μm, it is difficult to secure dispersibility at the time of preparing a slurry, such that non-uniformity may be increasingly exhibited. In the case in which the average particle size of the ferrite is more than 5 μm, it may be difficult to perform low temperature sintering due to deterioration in driving force with respect to the low temperature sintering, thereby having problems in achieving electrical properties and being applied to a product having ultra small size. The shape of the ferrite is not specifically limited, and the ferrite may have various shapes such as a spherical shape, an oval shape, and the like.

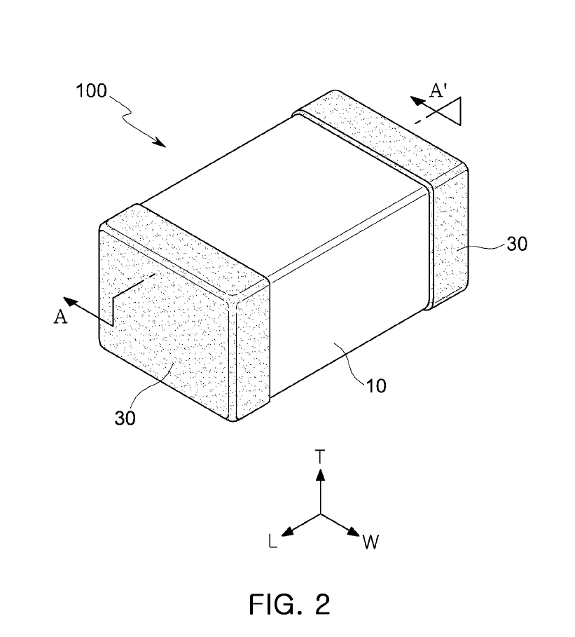

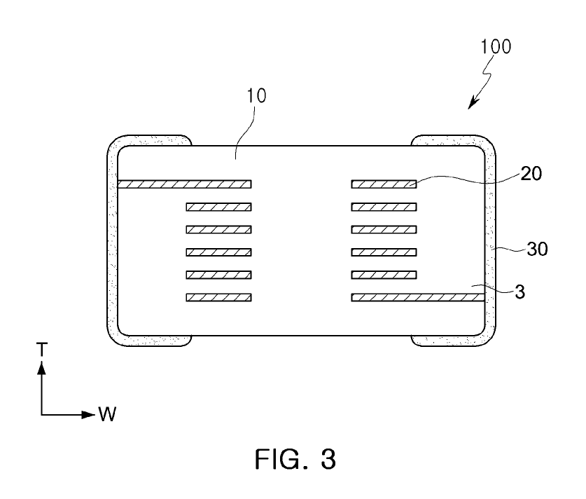

FIG. 2 is a perspective view schematically showing a multilayer electronic component according to another exemplary embodiment of the present disclosure; and FIG. 3 is a cross-sectional view taken along line A-A′ of FIG. 2.

Referring to FIGS. 2 and 3, a multilayer electronic component 100 according to the exemplary embodiment of the present disclosure may include a magnetic body 10 in which a plurality of magnetic layers 3 are laminated; a conductive pattern 20 formed in the magnetic body 10; and external electrodes 30 formed on at least one end surface of the magnetic body and electrically connected to the conductive pattern.

Hereinafter, a multilayer electronic component according to an exemplary embodiment of the present disclosure, in particular a multilayer inductor, will be described. However, the present disclosure is not limited thereto.

In the multilayer inductor according to the exemplary embodiment of the present disclosure, a “length direction” refers to an “L” direction of FIG. 2, a “width direction” refers to a “W” direction of FIG. 2, and a “thickness direction” refers to a “T” direction of FIG. 2. Here, the “thickness direction” is the same as a direction in which magnetic layers are laminated, a “lamination direction.”

The magnetic body 10 formed by laminating the plurality of magnetic layers 3 may include a ferrite and a glass, wherein the glass may include an oxide including at least one selected from a group consisting of silicon (Si) and boron (B); an oxide including at least one selected from a group consisting of lithium (Li), potassium (K) and calcium (Ca); an oxide including at least one selected from a group consisting of vanadium (V) and manganese (Mn); and an oxide including at least one selected from a group consisting of titanium (Ti) and aluminum (Al).

The glass may include a (Si, B)-b(Li, K, Ca)-c(V, Mn)-d(Ti, Al), wherein a refers to a molar ratio of the oxide including at least one selected from a group consisting of silicon (Si) and boron (B), b refers to a molar ratio of the oxide including at least one selected from a group consisting of lithium (Li), potassium (K) and calcium (Ca), c refers to a molar ratio of the oxide including at least one selected from a group consisting of vanadium (V) and manganese (Mn), and d refers to a molar ratio of the oxide including at least one selected from a group consisting of titanium (Ti) and aluminum (Al).

In this case, according to the exemplary embodiment of the present disclosure, a, b, c, and d may satisfy the following equation: a+b+c+d=100(mol %), and may satisfy the following equations: 30(mol %)≦a≦60(mol %), 10(mol %)≦b≦30(mol %), 10(mol %)≦c≦40(mol %), and 1(mol %)≦d≦20(mol %).

Any overlapped description with the characteristics of the magnetic composition according to the above-described embodiment of the present disclosure will be omitted.

A material for the conductive pattern 20 formed in the magnetic body 10 is not specifically limited, but a conductive paste formed of, for example, at least one of silver (Ag), lead (Pg), platinum (Pt), nickel (Ni), and copper (Cu) may be used.

The external electrodes 30 electrically connected to the conductive pattern 20 may be formed of the same conductive metal as that of the conductive pattern 20, but is not limited thereto. For example, copper (Cu), silver (Ag), and nickel (Ni) may be used alone or alloys thereof may be used. A conductive paste prepared by mixing an oxide-based glass powder, a base resin, and an organic vehicle with the conductive metal may be used to form the external electrodes 30.

Hereinafter, although the present disclosure will be described in detail through the following Examples and Comparative Examples, the description should not be construed as being limited to the scope of the present disclosure, but is intended to help in an understanding of the present disclosure.

### EXAMPLES

A slurry was prepared to contain a Ni—Zn—Cu-based ferrite and a glass prepared according to each composition shown in the following Table 1 at an amount of 20 wt % and the slurry was applied to carrier films and dried to prepare a plurality of magnetic sheets.

A copper (Cu) conductive paste was applied to the magnetic sheets using a screen to form conductive patterns. In addition, the slurry was applied to a portion of the magnetic sheet around the conductive pattern to be level with the conductive pattern to form a multilayer carrier.

The multilayer carriers having the conductive patterns formed therein were repeatedly stacked to form a multilayer body, wherein the conductive patterns were electrically connected to each other to have a coil pattern in a stacking direction. Here, a via electrode was formed in the magnetic sheet, such that it electrically connected an upper conductive pattern and a lower conductive pattern to each other, having the magnetic sheet interposed therebetween.

The multilayer body was isostatically pressed under a pressure of 1,000 kgf/cm² at a temperature of 85° C. The pressed multilayer body was cut into individual chips, and the cut chip was debinded by being maintained at 230° C. under an air atmosphere for 40 hours.

A sintering process was performed at a temperature of 750° C. for 1 hour. Here, the chip after sintering was manufactured to have a size of 2.5 mm×2.0 mm(L×W), 2520.

Then, external electrodes were formed through applying, firing, and plating processes, and the like, using a copper (Cu) conductive paste.

The following Table 1 shows results obtained by measuring permeability, specific resistance and high frequency specific resistance values of multilayer inductors depending on respective glass compositions.

TABLE 1

| | | | | | | | | | | | Inductor Evaluation Results | | | |
|---|---|---|---|---|---|---|---|---|---|---|---|---|---|---|
| | | | | | | | | | | | | | High | |
| | | | | | | | | | | | | | Frequency | |
| | Glass Composition (mol %) | | | | | | | | | | | Specific | Specific | Final |
| | B | Si | Li | K | Ca | V | Mn | Ti | Al | Sum | Permeability | Resistance | Resistance | Decision |
| Example 1 | 10 | 15 | 10 | 10 | 10 | 15 | 20 | 5 | 5 | 100 | Δ | Δ | X | Δ |
| Example 2 | 15 | 10 | 10 | 10 | 10 | 20 | 15 | 5 | 5 | 100 | X | Δ | Δ | Δ |
| Example 3 | 30 | 40 | 5 | 5 | — | 5 | 5 | 5 | 5 | 100 | X | X | X | X |
| Example 4 | 30 | 25 | 2 | 2 | 2 | 4 | 20 | 5 | 10 | 100 | Δ | Δ | Δ | Δ |
| Example 5 | 20 | 30 | 5 | 5 | 25 | 8 | 2 | 3 | 2 | 100 | X | Δ | Δ | X |
| Example 6 | 30 | 30 | 5 | 5 | 10 | 2 | 2 | 6 | 10 | 100 | Δ | Δ | ◯ | Δ |
| Example 7 | 30 | 30 | 5 | 5 | 10 | 4 | 4 | 2 | 10 | 100 | ◯ | Δ | Δ | Δ |
| Example 8 | 15 | 15 | 5 | 5 | 5 | 25 | 20 | 6 | 4 | 100 | Δ | ◯ | X | X |
| Example 9 | 20 | 20 | 5 | 5 | 10 | 10 | 5 | 15 | 10 | 100 | X | X | X | X |
| Example 10 | 25 | 15 | 15 | 10 | 3 | 15 | 12 | — | 5 | 100 | ◯ | ◯ | ◯ | ◯ |
| Example 11 | 25 | 15 | 15 | 5 | 3 | 25 | 2 | 5 | 5 | 100 | ◯ | ◯ | ◯ | ◯ |
| Example 12 | 15 | 15 | 10 | 10 | 10 | 15 | 15 | 5 | 5 | 100 | ◯ | ◯ | ◯ | ◯ |
| Example 13 | 30 | 30 | 5 | 5 | 10 | 8 | 2 | 2 | 8 | 100 | ◯ | ◯ | ◯ | ◯ |
| Example 14 | 25 | 15 | 15 | 10 | 3 | 15 | 12 | — | 5 | 100 | ◯ | ◯ | ◯ | ◯ |
| Example 15 | 25 | 15 | 15 | 5 | 3 | 25 | 2 | 5 | 5 | 100 | ◯ | ◯ | ◯ | ◯ |
| Example 16 | 25 | 25 | 10 | 5 | 3 | 20 | 2 | 5 | — | 100 | ◯ | ◯ | ◯ | ◯ |
| Example 17 | 20 | 10 | 10 | 5 | 5 | 28 | 12 | 5 | 5 | 100 | ◯ | ◯ | ◯ | ◯ |
| Comparative | 30 | 35 | 15 | 10 | 5 | — | — | 5 | — | 100 | Δ | Δ | Δ | Δ |
| Example 1 | | | | | | | | | | | | | | |
| Comparative | 30 | 35 | 20 | 15 | — | — | — | — | — | 100 | X | X | ◯ | X |
| Example 2 | | | | | | | | | | | | | | |
| Comparative | 30 | 30 | 20 | 5 | 5 | 10 | — | — | — | 100 | Δ | Δ | X | Δ |
| Example 3 | | | | | | | | | | | | | | |

1) Permeability Evaluation Basis

×: With respect to 200 Samples, an average permeability after sintering is lower than that of Comparative Example 1

Δ: With respect to 200 Samples, an average permeability after sintering is the same or similar to that of Comparative Example 1

◯: With respect to 200 Samples, an average permeability after sintering is increased by 10% or more as compared to Comparative Example 1

2) Specific Resistance Evaluation Basis

×: With respect to 200 Samples, an average specific resistance after sintering is lower than that of Comparative Example 1

Δ: With respect to 200 Samples, an average specific resistance after sintering is the same or similar to that of Comparative Example 1

◯: With respect to 200 Samples, an average permeability after sintering is increased by 10% or more as compared to Comparative Example 1

3) High Frequency Specific Resistance Evaluation Basis

×: With respect to 200 Samples, an average high frequency specific resistance after sintering is lower than that of Comparative Example 1

Δ: With respect to 200 Samples, an average high frequency specific resistance after sintering is the same or similar to that of Comparative Example 1

◯: With respect to 200 Samples, an average high frequency specific resistance after sintering is increased by 10% or more as compared to Comparative Example 1.

Referring to Table 1 above, in Comparative Example 1, to which a ferrite magnetic composition containing a conventional glass was applied, permeability, specific resistance, and high frequency specific resistance values required improvement. In Comparative Example 2, not including [vanadium (V) and manganese (Mn)] and [titanium (Ti) and aluminum (Al)], the ferrite grain was not completely grown, such that the permeability and specific resistance values were decreased, and in Comparative Example 3, not including [titanium (Ti) and aluminum (Al)], the glass was useful ingrain growth of the ferrite, but boundaries between the grown grains were not clear, and the high frequency specific resistance value was low.

In Examples 1 and 2, in which a content of [silicon (Si) and boron (B)] was less than 30 mol %, solubility thereof to the ferrite was decreased, such that sintering was not completely achieved, whereby electrical properties such as permeability, specific resistance, and high frequency specific resistance were degraded even as compared to Comparative Example 1. In Example 3, in which the content of [silicon (Si) and boron (B)] was more than 60 mol %, a melting point of the glass was increased, which was not useful for promoting the grain growth of the ferrite, whereby improvement of permeability, specific resistance, and high frequency specific resistance was insignificant.

In Example 4, in which the content of [lithium (Li), potassium (K) and calcium (Ca)] was less than 10 mol %, permeability, specific resistance, and high frequency specific resistance values were insignificant. In Example 5, in which the content of [lithium (Li), potassium (K) and calcium (Ca)] was more than 30 mol %, the melting point of the glass was within a proper range to allow the ferrite to be sintered, but the size of the grain was not grown, whereby satisfying permeability could not be obtained.

In Examples 6 and 7, in which the content of [vanadium (V) and manganese (Mn)] was less than 10 mol %, the grain growth of the ferrite was promoted by the glass, but a grain boundary resistance sufficient for the grain boundary was not formed, such that specific resistance and high frequency specific resistance values were not sufficiently improved. In Example 8, in which the content of [vanadium (V) and manganese (Mn)] was more than 40 mol %, since phase-stability of the glass was unstable, a devitrification phenomenon occurred at the time of melting, and thus, the prepared powder exhibited non-uniform properties such that it may be difficult to control physical properties thereof. In addition, an excessive amount of [vanadium (V) and manganese (Mn)] was reacted with the ferrite grains to decrease internal resistance, resulting in deterioration in high frequency specific resistance.

In Example 9, in which the content of [titanium (Ti) and aluminum (Al)] was more than 20 mol %, when a glass oxide was formed using TiO₂, Al₂O₃ naturally having a high melting point, a melting point was increased and a high temperature viscosity was increased to decrease utility.

In Examples 10 to 17, satisfying a, b, c and d values of a (Si,B)-b(Li,K,Ca)-c(V,Mn)-d(Ti,Al) according to exemplary embodiments of the present disclosure, the grain growth of the ferrite obtained by sintering the slurry to which the glass satisfying the above values was applied was sufficiently achieved, and [vanadium (V) and manganese (Mn)] for improving grain boundary resistance was uniformly distributed only in the grain boundaries and did not react with the grains, whereby all of permeability, specific resistance, and high frequency specific resistance were improved by 10% or more as compared to Comparative Example 1.

In conclusion, according to the exemplary embodiment of the present disclosure, the magnetic body of the multilayer inductor may include the ferrite and the glass having the composition of a(Si, B)-b(Li, K, Ca)-c(V, Mn)-d(Ti, Al), wherein when a, b, c and d satisfy the following equations: a+b+c+d=100(mol %), 30(mol %)≦a≦60(mol %), 10(mol %)≦b≦30(mol %), 10(mol %)≦c≦40(mol %), and 1(mol %)≦d≦20(mol %), the multilayer inductor may achieve remarkably improved permeability, specific resistance, and high frequency specific resistance.

As set forth above, according to exemplary embodiments of the present disclosure, a magnetic composition and a multilayer electronic component manufactured by using the same may include a glass component capable of not reacting with a ferrite grain but being uniformly distributed only in a grain boundary, instead of using an existing glass component, thereby achieving improved permeability, specific resistance and high frequency specific resistance.

While exemplary embodiments have been shown and described above, it will be apparent to those skilled in the art that modifications and variations could be made without departing from the spirit and scope of the present disclosure as defined by the appended claims.

What is claimed is:

1. A magnetic composition comprising:
a ferrite; and
a glass,
wherein the glass includes:
an oxide including at least one selected from a group consisting of silicon (Si) and boron (B);
an oxide including at least one selected from a group consisting of lithium (Li), potassium (K) and calcium (Ca);
an oxide including at least one selected from a group consisting of vanadium (V) and manganese (Mn); and
an oxide including at least one selected from a group consisting of titanium (Ti) and aluminum (Al).

2. The magnetic composition of claim 1, wherein the glass includes the oxide including at least one selected from a group consisting of vanadium (V) and manganese (Mn) in an amount of 10 mol % to 40 mol %.

3. The magnetic composition of claim 1, wherein when a molar ratio of the oxide including at least one selected from a group consisting of silicon (Si) and boron (B) is a, a molar ratio of the oxide including at least one selected from a group consisting of lithium (Li), potassium (K) and calcium (Ca) is b, a molar ratio of the oxide including at least one selected from a group consisting of vanadium (V) and manganese (Mn) is c, and a molar ratio of the oxide including at least one selected from a group consisting of titanium (Ti) and aluminum (Al) is d, a, b, c, and d satisfy the following equations:
a+b+c+d=100(mol %);
30(mol %)≦a≦60(mol %);
10(mol %)≦b≦30(mol %);
10(mol %)≦c≦40(mol %); and
1(mol %)≦d≦20(mol %).

4. The magnetic composition of claim 1, wherein the glass is included in an amount of 0.5 wt % to 20 wt %.

5. The magnetic composition of claim 1, wherein the glass has an average particle size of 0.05 μm to 5 μm.

6. The magnetic composition of claim 1, wherein the ferrite has an average particle size of 0.05 μm to 5 μm.

7. The magnetic composition of claim 1, wherein the ferrite includes at least one selected from a group consisting of a Mn—Zn-based ferrite, a Ni—Zn-based ferrite, a Ni—Zn—Cu-based ferrite, a Mn—Mg-based ferrite, a Ba-based ferrite, and a Li-based ferrite.

8. A multilayer electronic component comprising:
a magnetic body in which a plurality of magnetic layers are laminated;
a conductive pattern formed in the magnetic body; and
external electrodes formed on at least one end surface of the magnetic body and electrically connected to the conductive pattern,
wherein the magnetic body includes a ferrite and a glass, and
the glass includes:
an oxide including at least one selected from a group consisting of silicon (Si) and boron (B);
an oxide including at least one selected from a group consisting of lithium (Li), potassium (K) and calcium (Ca);
an oxide including at least one selected from a group consisting of vanadium (V) and manganese (Mn); and
an oxide including at least one selected from a group consisting of titanium (Ti) and aluminum (Al).

9. The multilayer electronic component of claim 8, wherein the glass includes the oxide including at least one selected from a group consisting of vanadium (V) and manganese (Mn) in an amount of 10 mol % to 40 mol %.

10. The multilayer electronic component of claim 8, wherein when a molar ratio of the oxide including at least one selected from a group consisting of silicon (Si) and boron (B) is a, a molar ratio of the oxide including at least one selected from a group consisting of lithium (Li), potassium (K) and calcium (Ca) is b, a molar ratio of the oxide including at least one selected from a group consisting of vanadium (V) and manganese (Mn) is c, and a molar ratio of the oxide including at least one selected from a group consisting of titanium (Ti) and aluminum (Al) is d, a, b, c, and d satisfy the following equations:
a+b+c+d=100(mol %);
30(mol %)≦a≦60(mol %);
10(mol %)≦b≦30(mol %);
10(mol %)≦c≦40(mol %); and
1(mol %)≦d≦20(mol %).

11. The multilayer electronic component of claim 8, wherein the magnetic body includes the glass in an amount of 0.5 wt % to 20 wt %.

12. The multilayer electronic component of claim 8, wherein the glass has an average particle size of 0.05 μm to 5 μm.

13. The multilayer electronic component of claim 8, wherein the ferrite has an average particle size of 0.05 μm to 5 μm.

14. The multilayer electronic component of claim 8, wherein the ferrite includes at least one selected from a group consisting of a Mn—Zn-based ferrite, a Ni—Zn-based ferrite, a Ni—Zn—Cu-based ferrite, a Mn—Mg-based ferrite, a Ba-based ferrite, and a Li-based ferrite.
